(19) United States
(12) Patent Application Publication
(10) Pub. No.: US 2018/0127517 A1
(43) Pub. Date: May 10, 2018

(54) Hydrophobically modified nanocellulose crystal and a method for hydrophobic grafting modification of nanocellulose crystals

(71) Applicant: PetroChina Company Limited, Beijing (CN)

(72) Inventors: Jianhui LUO, Beijing (CN); Xinxiang ZHANG, Beijing (CN); Baoliang PENG, Beijing (CN); Pingmei WANG, Beijing (CN); Bin DING, Beijing (CN); Lipeng HE, Beijing (CN); Xiangfei GENG, Beijing (CN)

(21) Appl. No.: 15/799,589

(22) Filed: Oct. 31, 2017

(30) Foreign Application Priority Data
Nov. 9, 2016 (CN) 2016109938651

(51) Int. Cl. C08B 15/00; C08L 51/02; C08F 251/02; C08J 7/12; C08G 77/04; B01J 31/30; B01D 71/34; B82Y 30/00

(52) U.S. Cl. CPC C08B 15/00; C08L 51/02; C08F 251/02; B82Y 30/00; C08G 77/04; B01J 31/30; B01D 71/34; C08J 7/12

(57) ABSTRACT

The present disclosure relates to a hydrophobically modified nanocellulose crystal and a method for hydrophobic grafting modification of nanocellulose crystals, comprising the steps: mixing the nanocellulose crystals with a saturated alkane, and stirring the resultant at room temperature or under a heating condition; while stirring, adding in sequence a polymethylhydrosiloxane containing a silicon-hydrogen bond and a catalyst; continuously stirring to complete the dehydrogenation reaction, then obtaining a mixed solution; and filtering the mixed solution by a polyvinylidene fluoride membrane, then drying it to complete the hydrophobic modification. A —Si—O—C-chemical bonding is formed between the polymethylhydrosiloxane and the nanocellulose crystal in the method, enabling improvement of the hydrophobicity and water resistance of the nanocellulose crystal.

### TECHNICAL FIELD

The present disclosure relates, in particular, to a method for hydrophobic grafting modification of nanocellulose crystals, which belongs to the technical field of hydrophobic grafting modification for nanoparticle surfaces.

### BACKGROUND

Silicone materials are widely used for their excellent insulation, flame resistance, heat insulation, radiation resistance, and high- and low-temperature resistance. However, the silicone raw rubbers have very low strength, thus need to be added with a large amount of reinforcing agents to improve its strength. Currently, the reinforcing agent as frequently used is the white carbon black, which can effectively improve the strength of silicone materials. Compared with the traditional white carbon black, nanocellulose crystals are a kind of emerging nano-materials having a structure of a nano-rod-like crystal with high crystallinity, having a length of about 10 times size of the diameter. As a reinforcing material, this rod-like nanocellulose crystal will be directionally aligned along the direction of the external force within the silicone material in the processing, and such directional alignment will increase the transmission distance of the external stress in the silicone material substrate, resulting in more effective dispersion of the external forces on the silicone material, and better reinforcing performance.

Nanocellulose crystals are problematic in terms of, such as, agglomeration and poor compatibility with the substrates when it is used as a reinforcing agent for a composite, due to its large polarity and specific surface area. Therefore, there is a need for the nanocellulose crystals to be subjected to surface hydrophobic modification. However, it is difficult to subject the cellulose, including nanocellulose, to hydrophobic grafting modification by using organosiloxanes in the prior art, mainly because the —Si—OH formed from siloxanes hardly react with the —C—OH on the surface of cellulose to form a —Si—O—C-bond. Therefore, as for the methods for the hydrophobic modification of nanocelluloses by using organosiloxanes so far reported, the hydrophobic modifiers may be only attached to the surface of the nanocellulose by adsorption, causing poor durability of the hydrophobic modification.

### SUMMARY OF THE DISCLOSURE

In order to solve the above technical problems, an object of the present disclosure is to provide a hydrophobically modified nanocellulose crystal and a method for hydrophobic grafting modification of nanocellulose crystals, in which a chemical bond of —Si—O—C— is formed between polymethylhydrosiloxane and a nanocellulose crystal, and thus the hydrophobicity and water resistance of nanocellulose crystals can be improved.

In order to achieve the above object, the present disclosure provides a method for hydrophobic grafting modification of nanocellulose crystals, comprising the steps of:

mixing the nanocellulose crystals with a saturated alkane, and dispersing the nanocellulose crystals forcibly in the saturated alkane by high-speed stirring at room temperature or under a heating condition; while stirring, adding in sequence a polymethylhydrosiloxane containing a silicon-hydrogen bond and a catalyst; continuously stirring to complete the dehydrogenation reaction, that is, grafting the polymethylhydrosiloxane onto the surface of the nanocellulose crystals via a chemical bond of —Si—O—C—, to obtain a mixed solution; and filtering the mixed solution by a polyvinylidene fluoride membrane, drying it to complete the hydrophobic modification.

In the above method, it is preferred that the catalyst is a complex of chloroplatinic acid and isopropanol, a complex of chloroplatinic acid and 1,3-divinyl-1,1,3,3-tetramethyldisiloxane, a complex of chloroplatinic acid and 2,4,6,8-tetramethyl-2,4,6,8-tetravinylcyclotetrasiloxane, or an organotin salt.

In the above method, it is preferred that the saturated alkane is one of n-hexane, n-heptane, n-octane and n-nonane, or a combination thereof; the pore size of the polyvinylidene fluoride membrane is 0.45 microns; the rotate speed of the high-speed stirring is from 5000 rpm to 100000 rpm.

In the above method, it is preferred that the polymethylhydrosiloxane containing a silicon-hydrogen bond includes one or both of a side hydrogen-polymethylhydrosiloxane with a silicon-hydrogen bond in the side chain and a telohydrogen-polymethylhydrosiloxane with a silicon-hydrogen bond at the end;

The side hydrogen-polymethylhydrosiloxane has a molecular formula of:

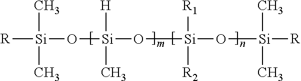

wherein R, R₁ and R₂ are all organic groups, more preferably one of methyl, ethyl, propyl, phenyl and trifluoropropyl; m≥0, n≥0, with m and n being an integer.

The telohydrogen-polymethylhydrosiloxane has a molecular formula of:

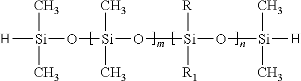

wherein R and R₁ are both organic groups, more preferably one of methyl, ethyl, propyl, phenyl and trifluoropropyl; m≥0, n≥0, with m and n being an integer.

In the above method, it is preferred that the side hydrogen-polymethylhydrosiloxane has a hydrogen content of from 0.01% to 1.5%, preferably from 0.2% to 1.5%; and the telohydrogen-polymethylhydrosiloxane has a hydrogen content of from 0.01% to 1.0%, preferably from 0.2% to 1.0%.

In the above method, it is preferred that the mass ratio of the nanocellulose crystal to the saturated alkane is from (1:10) to (1:100).

In the above method, it is preferred that the mass ratio of the polymethylhydrosiloxane containing a silicon-hydrogen bond to the nanocellulose crystal is from (0.1:1) to (2:1).

In the above method, it is preferred that, when a side hydrogen-polymethylhydrosiloxane having a hydrogen content of 0.2% is used, the mass ratio of the side hydrogen-polymethylhydrosiloxane to the nanocellulose crystal is from (0.6:1) to (2.0:1);

when a side hydrogen-polymethylhydrosiloxane having a hydrogen content of 1.0% is used, the mass ratio of the side hydrogen-polymethylhydrosiloxane to the nanocellulose crystal is from (0.2:1) to (2.0:1);

when a side hydrogen-polymethylhydrosiloxane having a hydrogen content of 1.5% is used, the mass ratio of the side hydrogen-polymethylhydrosiloxane to the nanocellulose crystal is from (0.1:1) to (2.0:1).

In the above method, it is preferred that the complex of chloroplatinic acid and isopropanol is added in an amount of from 10 to 1000 ppm with respect to the amount of the polymethylhydrosiloxane; the complex of chloroplatinic acid and 1,3-divinyl-1,1,3,3-tetramethyldisiloxane is added in an amount of from 10 to 1000 ppm with respect to the amount of the polymethylhydrosiloxane; the complex of chloroplatinic acid and 2,4,6,8-tetramethyl-2,4,6,8-tetravinylcyclotetrasiloxane is added in an amount of from 10 to 1000 ppm with respect to the amount of the polymethylhydrosiloxane; and the organotin salt is added in an amount of from 0.01% to 4% with respect to the amount of the polymethylhydrosiloxane.

In the above method, it is preferred that the heating temperature is from 25° C. to 150° C.; the stirring time is from 0.5 min to 30 min; and the drying temperature is from 40° C. to 150° C.

In the above method, it is preferred that the high-speed stirring is performed on a conventional device which can provide high-speed stirring or dispersing.

The present disclosure also provides a hydrophobically modified nanocellulose crystal prepared by the above-described method. It is preferred that the surface of hydrophobically modified nanocellulose crystal is grafted with hydroxyl groups.

In the method for hydrophobic grafting modification of nanocellulose crystals of the present disclosure, the polymethylhydrosiloxane containing a silicon-hydrogen bond has a good chemical inertness in absence of catalysts and does not participate in the reaction; however, in the presence of organotin or platinum catalyst, it can react with the nanocellulose crystals in a dehydrogenation reaction under room temperature or under a heating condition, so that it is grafted onto the surface of the nanocellulose crystal by forming a —Si—O—C— bond with the nanocellulose crystal, thereby preparing the polymethylhydrosiloxane-modified nanocellulose crystals by hydrophobic grafting. The nanocellulose crystals have good hydrophobicity and water resistance.

### DESCRIPTION OF THE DRAWINGS

FIG. 1 is a schematic representation for the contact angle of the nanocellulose crystals with water prepared in the Comparative Example and Examples 1-5.

FIG. 2 is a FTIR spectrum of the nanocellulose crystals prepared in the Comparative Example and Examples 1, 3 and 4.

FIG. 3 is a structure showing non-hydrophobically modified nanocellulose.

FIG. 4 illustrates an exemplary process for the reaction of nanocellulose crystals modified with a side hydrogen-polymethylhydrosiloxane having a hydrogen content of 0.2%.

FIG. 5 illustrates an exemplary process for the reaction of nanocellulose crystals modified with a side hydrogen-polymethylhydrosiloxane having a hydrogen content of 1.0%.

FIG. 6 illustrates an exemplary process for the reaction of nanocellulose crystals modified with a side hydrogen-polymethylhydrosiloxane having a hydrogen content of 1.5%.

FIG. 7 illustrates an exemplary process for the reaction of nanocellulose crystals modified with a side telohydrogen-polymethylhydrosiloxane having a hydrogen content of 0.5%.

### DETAILED DESCRIPTION OF THE DISCLOSURE

The technical solutions of the present disclosure are now described in detail in order to provide more explicit understanding of the technical features, objects and advantages of the present disclosure, which are not to be interpreted as limitation of the implementable scope of the disclosure.

### COMPARATIVE EXAMPLE

The Comparative Example provides a method for hydrophobic grafting modification of nanocellulose crystals, comprising the steps of:

mixing 1.0 g of nanocellulose crystals and 50.0 g of n-hexane without adding any catalyst; disperse the nanocellulose crystals forcedly in the saturated alkane by high-speed shearing with a stirrer for 1 min at room temperature; filtering the samples through an polyvinylidene fluoride membrane with a pore size of 0.45 microns and placing the resultant in a vacuum oven and drying it at 45° C.

The structure of the non-hydrophobically modified nanocellulose is shown in FIG. 3.

The non-hydrophobically modified nanocellulose crystals contained a large amount of hydroxyl groups on their surfaces.

The non-hydrophobically modified nanocellulose crystals were measured in a contact angle test and water resistance test (test apparatus: Krüss DSA100 dynamic water contact angle measuring instrument).

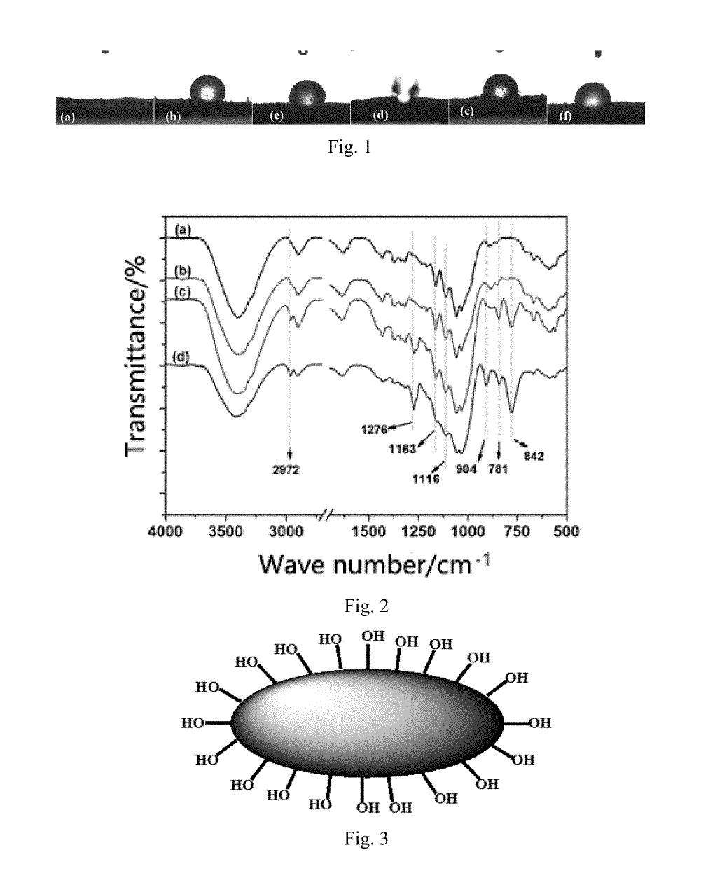

The non-hydrophobically modified nanocellulose crystals were evenly spread on a glass slide to measure their dynamic contact angle with water, and the measured droplet volume was 0.5 microliters. The results showed that the non-hydrophobically modified nanocellulose crystals were excellent in hydrophilicity. When the droplets came into contact with the surface of the nanocellulose crystals, the droplets were rapidly absorbed and thus the contact angle was 0 degree (as shown in FIG. 1(a)).

The non-hydrophobically modified nanocellulose crystals were added to a serum bottle filled with distilled water, shaken and the sample glass bottle was inverted. The results showed that the non-hydrophobically modified nanocellulose crystals were rapidly dispersed in the distilled water, indicating poor water resistance.

### Example 1

This Example provides a method for hydrophobic grafting modification of nanocellulose crystals, comprising the steps of:

Mixing 1.0 g of nanocellulose crystals and 20.0 g of n-hexane, dispersing the nanocellulose crystals forcedly in the saturated alkane by high-speed shearing at room temperature with a stirrer for 1 min; while high-speed stirring, adding in sequence 0.6 g of a side hydrogen-polymethylhydrosiloxane having a hydrogen content of 0.2% (i.e., the side hydrogen-polymethylhydrosiloxane is added in an amount of 60% with respect to the nanocellulose crystal) and 20 ppm of the complex of chloroplatinic acid and 1,3-divinyl-1,1,3,3-tetramethyldisiloxane (as a catalyst, in terms of Pt); continuously shearing for 1 min, to complete the modification; filtering the samples through an polyvinylidene fluoride membrane with a pore size of 0.45 microns, placing the resultant in a vacuum oven and drying it at 45° C.

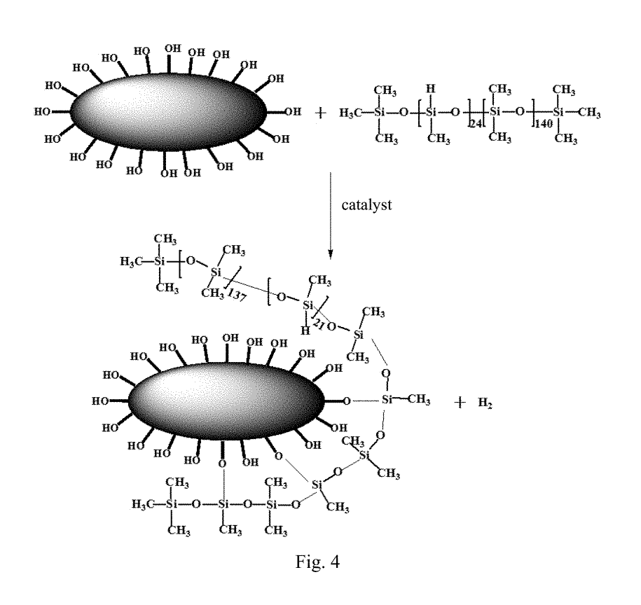

The reaction equation of the nanocellulose crystals modified with the side hydrogen-polymethylhydrosiloxane having a hydrogen content of 0.2% is shown in FIG. 4.

The equation in FIG. 4 is only an illustration of the modification process and does not reflect exactly the chemical reaction that occurs during the modification process. The surface of the unmodified nanocellulose contained a large amount of hydroxyl groups. After modification, a mass of hydrophobic polymethylhydrosiloxane chains were grafted to the surface of the nanocellulose due to the dehydrogenation reaction between the silicon-hydrogen bond of the side hydrogen-polymethylhydrosiloxane having a hydrogen content of 0.2% and the —C—OH bond on the surface of the nanocellulose, thereby significantly improving its hydrophobicity and water resistance.

The nanocellulose crystals modified with 60% of side hydrogen-polymethylhydrosiloxane (a hydrogen content of 0.2%) prepared in this Example were measured in the contact angle test and water resistance test (test apparatus: Krüss DSA100 dynamic water contact angle measuring instrument).

The nanocellulose crystals modified with 60% of side hydrogen-polymethylhydrosiloxane (a hydrogen content of 0.2%) prepared in this Example were evenly spread on a glass slide to measure their dynamic contact angle with water, and the measured droplet volume was 0.5 microliters. The results showed that the nanocellulose crystals modified with 60% of side hydrogen-polymethylhydrosiloxane (a hydrogen content of 0.2%) prepared in this Example were good in hydrophilicity. When the droplets came into contact with the surface of the nanocellulose crystals, the droplets were not absorbed, but formed a droplet with a contact angle of up to 118 degrees on the surface thereof (as shown in FIG. 1(b)).

The nanocellulose crystals modified with 60% of side hydrogen-polymethylhydrosiloxane (a hydrogen content of 0.2%) were added to a serum bottle filled with distilled water, shaken and the sample glass bottle was inverted. After inversion, the nanocellulose crystals modified with 60% of side hydrogen-polymethylhydrosiloxane (a hydrogen content of 0.2%) were completely floating on the surface of distilled water, indicating excellent water resistance, totally unwettable by water.

The FTIR spectra (as shown in FIG. 2(b)) of the nanocellulose crystal sample modified with the side hydrogen-polymethylhydrosiloxane having a hydrogen content of 0.2% were measured using a Fourier infrared spectrometer. Compared with the unmodified nanocellulose crystals (as shown in FIG. 2(a)), the nanocellulose crystal sample modified with the side hydrogen-polymethylhydrosiloxane having a hydrogen content of 0.2% had an absorption peak of Si—CH₃ appeared at 1276 cm⁻¹ and 842 cm⁻¹, and a methyl absorption peak appeared at 2972 cm⁻¹, indicating a chemical reaction between the side hydrogen-polymethylhydrosiloxane and the nanocellulose crystal, causing the side hydrogen-polymethylhydrosiloxane grafted onto the surface of the nanocellulose crystal via —Si—O—C. It is the large number of hydrophobic polymethylhydrosiloxane chains grafted onto the surface of the nanocellulose crystals that significantly improve the hydrophobicity and water resistance thereof.

### Example 2

This Example provides a method for hydrophobic grafting modification of nanocellulose crystals, comprising the steps of:

Mixing 1.0 g of nanocellulose crystals and 50.0 g of n-hexane, dispersing the nanocellulose crystals forcedly in the saturated alkane by high-speed shearing at room temperature with a stirrer for 1 min; while high-speed stirring, adding in sequence 0.1 g of a side hydrogen-polymethylhydrosiloxane having a hydrogen content of 1.0% (i.e., the side hydrogen-polymethylhydrosiloxane is added in an amount of 10% with respect to the nanocellulose crystal) and 20 ppm of the complex of chloroplatinic acid and 1,3-divinyl-1,1,3,3-tetramethyldisiloxane (as a catalyst, in terms of Pt); continuously shearing for 1 min, to complete the modification; filtering the samples through an polyvinylidene fluoride membrane with a pore size of 0.45 microns, placing the resultant in a vacuum oven and drying it at 45° C.

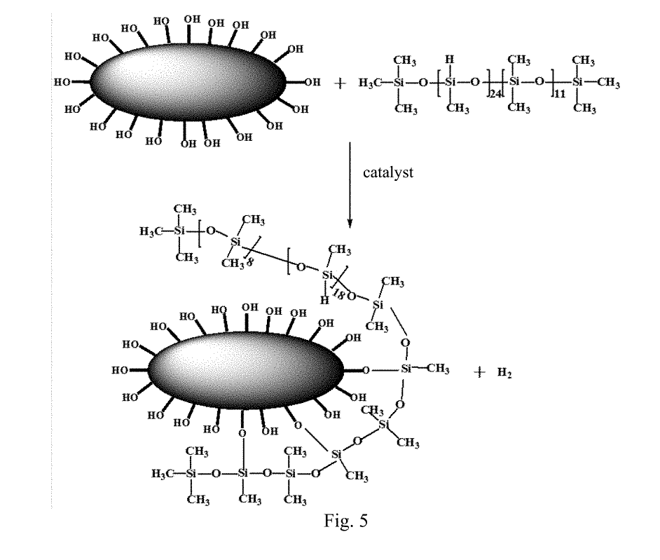

The reaction equation of the nanocellulose crystals modified with the side hydrogen-polymethylhydrosiloxane having a hydrogen content of 1.0% is shown in FIG. 5.

The equation in FIG. 5 is only an illustration of the modification process and does not reflect exactly the chemical reaction that occurs during the modification process. Like the case of the side hydrogen-polymethylhydrosiloxane having a hydrogen content of 0.2%, when the nanocellulose crystals was modified with the side hydrogen-polymethylhydrosiloxane having a hydrogen content of 1.0%, the dehydrogenation reaction also occurred and a large amount of hydrophobic polymethylhydrosiloxane chains were also grafted to its surface.

The nanocellulose crystals modified with 10% of side hydrogen-polymethylhydrosiloxane (a hydrogen content of 1.0%) prepared in this Example were measured in the contact angle test and water resistance test (test apparatus: Krüss DSA100 dynamic water contact angle measuring instrument).

The nanocellulose crystals modified with 10% of side hydrogen-polymethylhydrosiloxane (a hydrogen content of 1.0%) prepared in this Example were evenly spread on a glass slide to measure their dynamic contact angle with water, and the measured droplet volume was 0.5 microliters. The results showed that the nanocellulose crystals modified with 10% of side hydrogen-polymethylhydrosiloxane (a hydrogen content of 1.0%) prepared in this Example were good in hydrophilicity. When the droplets came into contact with the surface of the nanocellulose crystals, the droplets were not absorbed, but formed a droplet with a contact angle of up to 110 degrees on the surface thereof (as shown in FIG. 1(c)).

The nanocellulose crystals modified with 10% of side hydrogen-polymethylhydrosiloxane (a hydrogen content of 1.0%) were added to a serum bottle filled with distilled water, shaken and the sample glass bottle was inverted. After inversion, the nanocellulose crystals modified with 10% of side hydrogen-polymethylhydrosiloxane (a hydrogen content of 1.0%) were completely floating on the surface of distilled water, indicating excellent water resistance, totally unwettable by water.

### Example 3

This Example provides a method for hydrophobic grafting modification of nanocellulose crystals, comprising the steps of:

Mixing 1.0 g of nanocellulose crystals and 100.0 g of n-hexane, dispersing the nanocellulose crystals forcedly in the saturated alkane by high-speed shearing at room temperature with a stirrer for 1 min; while high-speed stirring, adding in sequence 0.6 g of side hydrogen-polymethylhydrosiloxane having a hydrogen content of 1.0% (i.e., the side hydrogen-polymethylhydrosiloxane is added in an amount of 60% with respect to the nanocellulose crystal) and 20 ppm of the complex of chloroplatinic acid and 1,3-divinyl-1,1,3,3-tetramethyldisiloxane (as a catalyst, in terms of Pt); continuously shearing for 1 min, to complete the modification; filtering the samples through an polyvinylidene fluoride membrane with a pore size of 0.45 microns, placing the resultant in a vacuum oven and drying it at 45° C.

The nanocellulose crystals modified with 60% of side hydrogen-polymethylhydrosiloxane (a hydrogen content of 1.0%) prepared in this Example were measured in the contact angle test and water resistance test (test apparatus: Krüss DSA100 dynamic water contact angle measuring instrument).

The nanocellulose crystals modified with 60% of side hydrogen-polymethylhydrosiloxane (a hydrogen content of 1.0%) prepared in this Example were evenly spread on a glass slide to measure their dynamic contact angle with water, and the measured droplet volume was 0.5 microliters. The results showed that the nanocellulose crystals modified with 60% of side hydrogen-polymethylhydrosiloxane (a hydrogen content of 1.0%) prepared in this Example were excellent in hydrophilicity. When the droplets came into contact with the surface of the nanocellulose crystals, the droplets rolled away rapidly from its surface, which is superhydrophobic (as shown in FIG. 1(d)).

The nanocellulose crystals modified with 60% of side hydrogen-polymethylhydrosiloxane (a hydrogen content of 1.0%) were added to a serum bottle filled with distilled water, shaken and the sample glass bottle was inverted. After inversion, the nanocellulose crystals modified with 60% of side hydrogen-polymethylhydrosiloxane (a hydrogen content of 1.0%) were completely floating on the surface of distilled water, indicating excellent water resistance, totally unwettable by water.

The FTIR spectra (as shown in FIG. 2(c)) of the nanocellulose crystal sample modified with the side hydrogen-polymethylhydrosiloxane having a hydrogen content of 1.0% were measured using a Fourier infrared spectrometer. Also, compared with the unmodified nanocellulose crystals (as shown in FIG. 2(a)), the nanocellulose crystal sample modified with the side hydrogen-polymethylhydrosiloxane having a hydrogen content of 1.0% had an absorption peak of Si—CH₃ appeared at 1276 cm⁻¹ and 842 cm⁻¹, and a methyl absorption peak appeared at 2972 cm⁻¹, indicating the side hydrogen-polymethylhydrosiloxane having a hydrogen content of 1.0% grafted onto the surface of nanocarbon crystals via a chemical bonding.

### Example 4

This Example provides a method for hydrophobic grafting modification of nanocellulose crystals, comprising the steps of:

Mixing 1.0 g of nanocellulose crystals and 50.0 g of n-hexane, dispersing the nanocellulose crystals forcedly in the saturated alkane by high-speed shearing at room temperature with a stirrer for 1 min; while high-speed stirring, adding in sequence 0.6 g of a side hydrogen-polymethylhydrosiloxane having a hydrogen content of 1.5% (i.e., the side hydrogen-polymethylhydrosiloxane is added in an amount of 60% with respect to the nanocellulose crystal) and 20 ppm of the complex of chloroplatinic acid and 2,4,6,8-tetramethyl-2,4,6,8-tetravinylcyclotetrasiloxane (as a catalyst, in terms of Pt); continuously shearing for 1 min, to complete the modification; filtering the samples through an polyvinylidene fluoride membrane with a pore size of 0.45 microns, placing the resultant in a vacuum oven and drying it at 45° C.

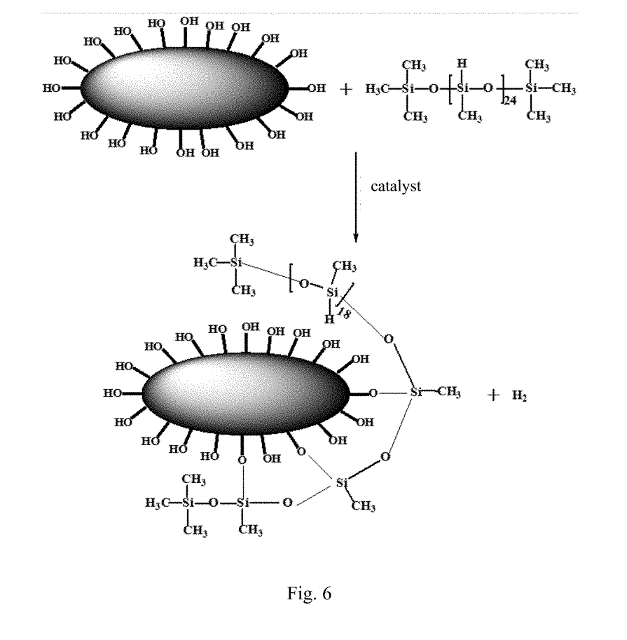

The reaction equation of the nanocellulose crystals modified with the side hydrogen-polymethylhydrosiloxane having a hydrogen content of 1.5% is shown in FIG. 6.

The equation in FIG. 6 only an illustration of the modification process and does not reflect exactly the chemical reaction that occurs during the modification process. Like the case of the side hydrogen-polymethylhydrosiloxanes having a hydrogen content of 0.2% and 1.0%, when the nanocellulose crystals was modified with the side hydrogen-polymethylhydrosiloxane having a hydrogen content of 1.5%, the dehydrogenation reaction also occurred and a large amount of hydrophobic polymethylhydrosiloxane chains were also grafted to its surface.

The nanocellulose crystals modified with 60% of side hydrogen-polymethylhydrosiloxane (a hydrogen content of 1.5%) prepared in this Example were measured in the contact angle test and water resistance test (test apparatus: Krüss DSA100 dynamic water contact angle measuring instrument).

The nanocellulose crystals modified with 60% of side hydrogen-polymethylhydrosiloxane (a hydrogen content of 1.5%) prepared in this Example were evenly spread on a glass slide to measure their dynamic contact angle with water, and the measured droplet volume was 0.5 microliters. The results showed that the nanocellulose crystals modified with 60% of side hydrogen-polymethylhydrosiloxane (a hydrogen content of 1.5%) prepared in this Example were good in hydrophilicity. When the droplets came into contact with the surface of the nanocellulose crystals, the droplets were not absorbed, but formed a droplet with a contact angle of up to 100 degrees on the surface thereof (as shown in FIG. 1(e)).

The nanocellulose crystals modified with 60% of side hydrogen-polymethylhydrosiloxane (a hydrogen content of 1.5%) were added to a serum bottle filled with distilled water, shaken and the sample glass bottle was inverted. After inversion, the nanocellulose crystals modified with 60% of side hydrogen-polymethylhydrosiloxane (a hydrogen content of 1.5%) were completely floating on the surface of distilled water, indicating excellent water resistance, totally unwettable by water.

The FTIR spectra (as shown in FIG. 2(d)) of the nanocellulose crystal sample modified with the side hydrogen-polymethylhydrosiloxane having a hydrogen content of 1.5% were measured using a Fourier infrared spectrometer. Also, compared with the unmodified nanocellulose crystals (as shown in FIG. 2(a)), the nanocellulose crystal sample modified with the side hydrogen-polymethylhydrosiloxane having a hydrogen content of 1.5% had an absorption peak of Si—CH3 appeared at 1276 cm⁻¹ and 842 cm⁻¹, and a methyl absorption peak appeared at 2972 cm⁻¹, indicating the side hydrogen-polymethylhydrosiloxane having a hydrogen content of 1.5% grafted onto the surface of nanocarbon crystals via a chemical bond.

### Example 5

This Example provides a method for hydrophobic grafting modification of nanocellulose crystals, comprising the steps of:

Mixing 1.0 g of nanocellulose crystals and 50.0 g of n-hexane, dispersing the nanocellulose crystals forcedly in the saturated alkane by high-speed shearing at room temperature with a stirrer for 1 min; while high-speed stirring, adding in sequence 0.6 g of a telohydrogen-polymethylhydrosiloxane having a hydrogen content of 0.5% (i.e., the telohydrogen-polymethylhydrosiloxane is added in an amount of 60% with respect to the nanocellulose crystal) and 20 ppm of the complex of chloroplatinic acid and 1,3-divinyl-1,1,3,3-tetramethyldisiloxane (as a catalyst, in terms of Pt); continuously shearing for 1 min, to complete the modification; filtering the samples through an polyvinylidene fluoride membrane with a pore size of 0.45 microns, placing the resultant in a vacuum oven and drying it at 45° C.

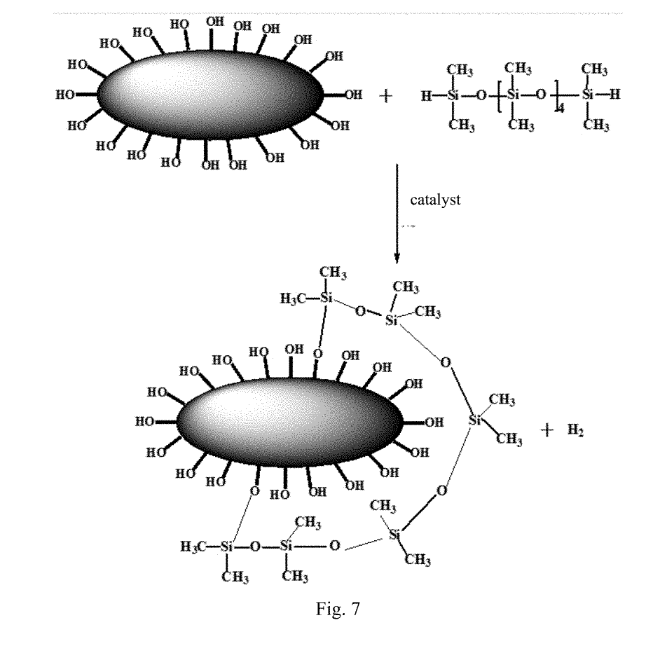

The reaction equation of the nanocellulose crystals modified with the telohydrogen-polymethylhydrosiloxane having a hydrogen content of 0.5% is shown in FIG. 7.

The equation in FIG. 7 is only an illustration of the modification process and does not reflect exactly the chemical reaction that occurs during the modification process. Like the case of the side hydrogen-polymethylhydrosiloxanes, when the nanocellulose crystals was modified with the telohydrogen-polymethylhydrosiloxan, the dehydrogenation reaction also occurred and a large amount of hydrophobic polymethylhydrosiloxane chains were also grafted to its surface.

The nanocellulose crystals modified with 60% of telohydrogen-polymethylhydrosiloxane (a hydrogen content of 0.5%) prepared in this Example were measured in the contact angle test and water resistance test (test apparatus: Krüss DSA100 dynamic water contact angle measuring instrument).

The nanocellulose crystals modified with 60% of telohydrogen-polymethylhydrosiloxane (a hydrogen content of 0.5%) prepared in this Example were evenly spread on a glass slide to measure their dynamic contact angle with water, and the measured droplet volume was 0.5 microliters. The results showed that the nanocellulose crystals modified with 60% of telohydrogen-polymethylhydrosiloxane (a hydrogen content of 0.5%) prepared in this Example were in good hydrophilicity. When the droplets came into contact with the surface of the nanocellulose crystals, the droplets were not absorbed, but formed a droplet with a contact angle of up to 115 degrees on the surface thereof (as shown in FIG. 1(f)).

The nanocellulose crystals modified with 60% of telohydrogen-polymethylhydrosiloxane (a hydrogen content of 0.5%) were added to a serum bottle filled with distilled water, shaken and the sample glass bottle was inverted. After inversion, the nanocellulose crystals modified with 60% of telohydrogen-polymethylhydrosiloxane (a hydrogen content of 0.5%) were completely floating on the surface of distilled water, indicating excellent water resistance, totally unwettable by water.

What is claimed is:

1. A method for hydrophobic grafting modification of nanocellulose crystals, comprising the steps of:
mixing the nanocellulose crystals with a saturated alkane, and stirring the resultant at room temperature or under a heating condition;
while stirring, adding in sequence a polymethylhydrosiloxane containing a silicon-hydrogen bond and a catalyst;
continuously stirring to complete the dehydrogenation reaction, then obtaining a mixed solution; and
filtering the mixed solution by a polyvinylidene fluoride membrane, then drying it to complete the hydrophobic modification.

2. The method according to claim 1, wherein the catalyst is a complex of chloroplatinic acid and isopropanol, a complex of chloroplatinic acid and 1,3-divinyl-1,1,3,3-tetramethyldisiloxane, a complex of chloroplatinic acid and 2,4,6,8-tetramethyl-2,4,6,8-tetravinylcyclotetrasiloxane, or an organotin salt.

3. The method according to claim 1, wherein the saturated alkane is one of n-hexane, n-heptane, n-octane and n-nonane, or a combination thereof; the pore size of the polyvinylidene fluoride membrane is 0.45 microns; the rotate speed of the stirring is from 5000 rpm to 100000 rpm.

4. The method according to claim 1, wherein the pore size of the polyvinylidene fluoride membrane is 0.45 microns.

5. The method according to claim 1, wherein the rotate speed of the stirring is from 5000 rpm to 100000 rpm.

6. The method according to claim 1, wherein the polymethylhydrosiloxane containing a silicon-hydrogen bond includes one or both of a side hydrogen-polymethylhydrosiloxane with a silicon-hydrogen bond in the side-chain and a telohydrogen-polymethylhydrosiloxane with a silicon-hydrogen bond at the end;
wherein the side hydrogen-polymethylhydrosiloxane has a molecular formula of: 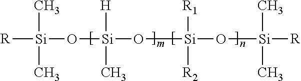
wherein R, R₁ and R₂ are organic groups, more preferably one of methyl, ethyl, propyl, phenyl and trifluoropropyl; m≥0, n≥0, with m and n being an integer; and
the telohydrogen-polymethylhydrosiloxane has a molecular formula of: 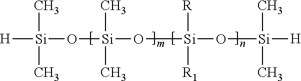
wherein R and R₁ are organic groups, more preferably one of methyl, ethyl, propyl, phenyl and trifluoropropyl; m≥0, n≥0, with m and n being an integer.

7. The method according to claim 1, wherein the side hydrogen-polymethylhydrosiloxane has a hydrogen content of from 0.01% to 1.5%, preferably from 0.2% to 1.5%.

8. The method according to claim 1, wherein the telohydrogen-polymethylhydrosiloxane has a hydrogen content of from 0.01% to 1.0%, preferably from 0.2% to 1.0%.

9. The method according to claim 1, wherein the mass ratio of the nanocellulose crystal to the saturated alkane is from (1:10) to (1:100).

10. The method according to claim 1, wherein the mass ratio of the polymethylhydrosiloxane containing silicon-hydrogen bond to the nanocellulose crystal is from (0.1:1) to (2:1).

11. The method according to claim 10, wherein when a side hydrogen-polymethylhydrosiloxane having a hydrogen content of 0.2% is used, the mass ratio of the side hydrogen-polymethylhydrosiloxane to the nanocellulose crystal is from (0.6:1) to (2.0:1).

12. The method according to claim 10, wherein when a side hydrogen-polymethylhydrosiloxane having a hydrogen content of 1.0% is used, the mass ratio of the side hydrogen-polymethylhydrosiloxane to the nanocellulose crystal is from (0.2:1) to (2.0:1).

13. The method according to claim 10, wherein when a side hydrogen-polymethylhydrosiloxane having a hydrogen content of 1.5% is used, the mass ratio of the side hydrogen-polymethylhydrosiloxane to the nanocellulose crystal is from (0.1:1) to (2.0:1).

14. The method according to claim 1, wherein the complex of chloroplatinic acid and isopropanol is added in an amount of from 10 to 1000 ppm with respect to the amount of the polymethylhydrosiloxane; the complex of chloroplatinic acid and 1,3-divinyl-1,1,3,3-tetramethyldisiloxane is added in an amount of from 10 to 1000 ppm with respect to the amount of the polymethylhydrosiloxane; the complex of chloroplatinic acid and 2,4,6,8-tetramethyl-2,4,6,8-tetravinylcyclotetrasiloxane is added in an amount of from 10 to 1000 ppm with respect to the amount of the polymethylhydrosiloxane.

15. The method according to claim 1, wherein the organotin salt is added in an amount of from 0.01% to 4% with respect to the amount of the polymethylhydrosiloxane.

16. The method according to claim 1, wherein the heating temperature is from 25° C. to 150° C.; the stirring time is from 0.5 min to 30 min; and the drying temperature is from 40° C. to 150° C.

17. A hydrophobically modified nanocellulose crystal prepared by the method according to claim 1.

18. The hydrophobically modified nanocellulose crystal according to claim 17, wherein the surface of hydrophobically modified nanocellulose crystal is grafted with hydroxyl groups.
